(19) United States
(12) Patent Application Publication
(10) Pub. No.: US 2015/0032551 A1
(43) Pub. Date: Jan. 29, 2015

(54) METHOD AND SYSTEM FOR CREATING, DELIVERING AND TRACKING PERSONALIZED ADVERTISEMENTS ON TARGETED CHANNELS

(71) Applicant: Cognizant Technology Solutions India Pvt. Ltd., Chennai (IN)

(72) Inventors: Vijai Ekambaram, Chennai (IN); Gautam Aggarwal, Noida (IN); ViswaKumar Ramasubramanian, Chennai (IN)

(73) Assignee: Cognizant Technology Solutions India Pvt. Ltd., Chennai (IN)

(21) Appl. No.: 14/027,505

(22) Filed: Sep. 16, 2013

(30) Foreign Application Priority Data
Jul. 23, 2013 (IN) 3289/CHE/2013

(51) Int. Cl. G06Q 30/02

(52) U.S. Cl. CPC G06Q 30/0276; G06Q 30/0271
USPC 705/14.67

(57) ABSTRACT

A method for creating and delivering personalized advertisements to end-user devices via associated communication channels is provided. The method enables selecting users, for whom personalized advertisements are to be created, from a plurality of users based on rules which are defined for selecting users based on: product related data obtained from product data sources and user related data of the plurality of users obtained from user data sources. Further, user related data of the selected users is mapped with product related data based on the rules to generate mapped data for each of the selected users. Further, personalized advertisements are created for each of the selected users based on the mapped data by merging images of the selected users with product advertisement images. Furthermore, the created personalized advertisements of each of the selected users are analyzed to deliver the created personalized advertisements to each of the selected users' end-user devices.

### FIELD OF THE INVENTION

The present invention relates generally to the field of targeted delivery of advertisements and more specifically to a method and system for creating and delivering personalized advertisements on targeted communication channels and tracking users' responses to the delivered personalized advertisements.

### BACKGROUND OF THE INVENTION

Delivering advertisements for commercial services/products as well as non-commercial services along with other content to users via various communication channels is a common trend. The various communication channels may include, but are not limited to, broadcast network including television network (satellite dish network, cable television network, and switched digital video network), printed media, and radio or any other medium of display. Of all the channels, television has a wide reach and due to its audio-video capabilities is the preferred platform for advertisers to advertise their services or products along with the broadcasted programming content. For instance, on television, advertisement content is typically delivered by interleaving with programming content during breaks. However, mere display of advertisements may have limited impact on users to translate into any desired action by the users such as sale of the advertised products/services.

This is so as it is observed that users (i.e. viewers) have a tendency to switch television channels during advertisement breaks. In addition, advertisements of irrelevant services/products which are of no interest to the users cause unnecessary disturbance to the users. In some instances, the irrelevant advertisements are intrusively inserted in the programming content which obstructs the programming content, and the forceful display of advertisements may annoy the user. Conventionally, while various methods of delivering targeted advertisements (based on demographics and behavior of users) exist, there is a continuing need for advertisements to be created in a manner that grab users' attention and thus increase their response to the advertised services/products. At the same time advertisements should be disseminated in a manner that causes minimal botheration to the users and is non-intrusive.

In light of the above, there is a need for a method and system which would facilitate user engagement towards advertised products that would in turn result in improved return on investment for the advertisers. In particular, there is a need for a method and system to create advertisements for individual users which would provide personalized experience of the advertised product(s). Further, there is a need for a method and system for tracking the impact of the advertisements by measuring the users' response to the personalized advertisements.

### SUMMARY OF THE INVENTION

A computer-implemented method for creating personalized advertisements and for delivering the created personalized advertisements to one or more end-user devices via associated communication channels is provided. The method comprises selecting one or more users, via a processor, for whom personalized advertisements are to be created, from a plurality of users based on one or more rules. The one or more rules are defined for selecting users based on: product related data obtained from one or more product data sources and user related data of the plurality of users obtained from one or more user data sources. The method further comprises mapping, via the processor, user related data of the selected users with product related data based on the one or more rules to generate mapped data for each of the selected users. Further, the method comprises creating, via the processor, personalized advertisements for each of the selected users based on the mapped data. The personalized advertisements are created by merging images of the selected users with one or more product advertisement images. Furthermore, the method comprises analyzing, via the processor, the created personalized advertisements of each of the selected users to deliver the created personalized advertisements to each of the selected users' end-user devices respectively.

A system for creating personalized advertisements and for delivering the created personalized advertisements to one or more end-user devices via associated communication channels is provided. The system comprises a rules engine in communication with a processor and configured to: select one or more users, for whom personalized advertisements are to be created, from a plurality of users based on one or more rules. The one or more rules are defined for selecting users based on: product related data obtained from one or more product data sources and user related data of the plurality of users obtained from one or more user data sources. The rules engine is further configured to map user related data of the selected one or more users with product related data based on the one or more rules to generate mapped data for each of the selected users. Further, the system comprises an advertisement mixer in communication with the processor and configured to create personalized advertisements for each of the selected users based on the mapped data. The personalized advertisements are created by merging images of the selected users with product advertisement images. Furthermore, the advertisement delivery engine in communication with the processor is configured to analyze the created personalized advertisements of each of the selected users and deliver the created personalized advertisements to the selected users' end-user devices respectively.

A computer program product comprising a non-transitory computer-readable medium having computer-readable program code stored thereon, the computer-readable program code comprising instructions that, when executed by a processor, cause the processor to select one or more users, for whom personalized advertisements are to be created, from a plurality of users based on one or more rules. The one or more rules being defined for selecting users based on: product related data obtained from one or more product data sources and user related data of the plurality of users obtained from one or more user data sources. The computer-readable program code comprising instructions that, when executed by the processor, cause the processor to map user related data of the selected one or more users with product related data based on the one or more rules to generate mapped data for each of the one or more selected users. Further, the computer-readable program code comprising instructions that, when executed by the processor, cause the processor to create personalized advertisements for the one or more selected users based on the mapped data. The personalized advertisements are created by merging images of the selected users with the product advertisement images. Furthermore, the computer-readable program code comprising instructions that, when executed by the processor, cause the processor to analyze the created personalized advertisements of each of the selected users and deliver the created personalized advertisements to the selected users' end-user devices respectively.

### BRIEF DESCRIPTION OF THE ACCOMPANYING DRAWINGS

The present invention is described by way of embodiments illustrated in the accompanying drawings wherein:

FIGS. 1A and 1B illustrate block diagrams of a system for creating and delivering personalized advertisements on targeted communication channels and tracking users' responses to the personalized advertisements, in accordance with various embodiments of the present invention

FIG. 2 is a detailed block diagram of a system for creating and delivering personalized advertisements on targeted communication channels and tracking users' responses to the personalized advertisements, in accordance with an embodiment of the present invention;

FIG. 3 is a flowchart of a method for creating and delivering personalized advertisements on targeted communication channels and tracking users' responses to the personalized advertisements, in accordance with an embodiment of the present invention;

FIG. 4 is a detailed block diagram of an advertisement delivery engine in communication with a tracking engine, in accordance with an embodiment of the present invention; and

FIG. 5 illustrates an exemplary computer system in which various embodiments of the present invention may be implemented.

### DETAILED DESCRIPTION OF THE INVENTION

A system and method is provided for creating, and delivering personalized advertisements on targeted communication channels and tracking users' responses to the delivered personalized advertisements. The invention provides for automated rule based matching of user details with user preferences of products and/or campaigning requirements of various products of retailers and advertising agencies. Further, the invention provides for creating personalized advertisements by merging images of the users with the product images/video. Furthermore, the invention provides for delivering created personalized advertisements to uniquely identified users by inserting the created personalized advertisements in the programming content which is broadcasted to all the users. In addition, the invention provides for tracking the users' response to the personalized advertisements in terms of purchase of the advertised product(s) made by the users.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

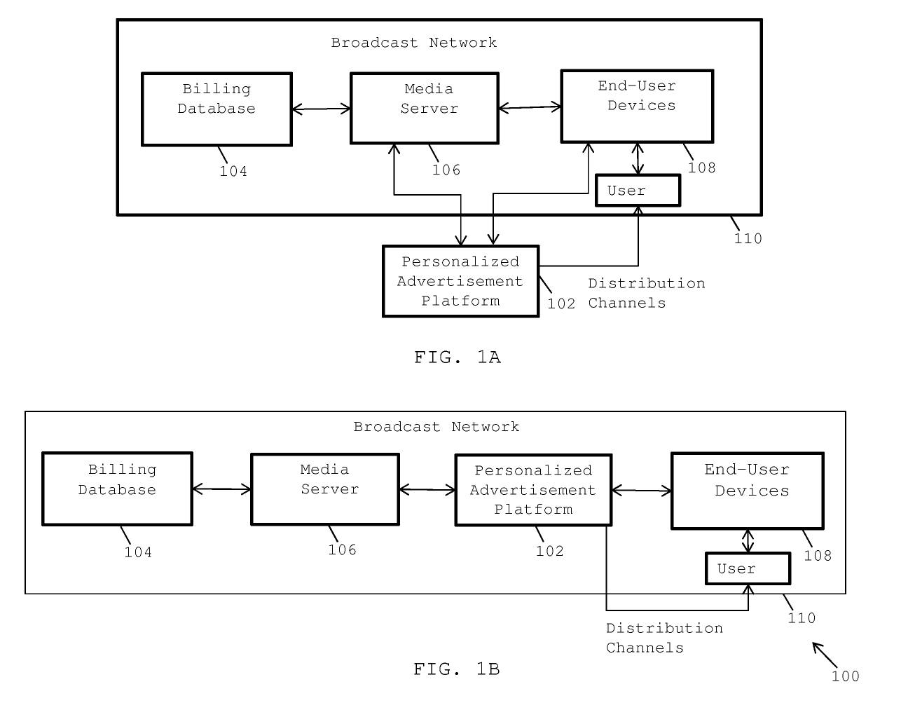

FIGS. 1A and 1B illustrate block diagrams of a system for creating and delivering personalized advertisements on targeted communication channels and tracking users' responses to the personalized advertisements, in accordance with various embodiments of the present invention. The targeted communication channels may include digital television environment, streaming video environment, switched digital video, and analog cable television.

In an embodiment of the present invention, the system 102 is a personalized advertisement platform which communicates with a media server 106 and one or more end-user devices 108 in a broadcast network 110. The broadcast network 110 broadcasts programming content to the end-user devices 108 via the media server 106. The personalized advertisement platform 102 is configured to create personalized advertisements for products or services and place the created personalized advertisements in the programming content for delivering the created personal advertisements to potential end-user devices 108. Further, the personalized advertisement platform 102 is configured to track responses of the selected users towards the advertised product/services via various distribution channels (as shown in FIGS. 1A and 1B). The personalized advertisement platform 102 is explained in detail in later sections of the specification. The end-user devices 108 receive the broadcasted programming content via respective communication channels. Examples of end-user devices 108 include analog cable television, set-top box television, digital cable television etc. Other examples of end-user devices 108 may include smart television, Internet Protocol television (IPTV), and in-store displays in retail outlets.

Further, the broadcast network 110 includes a billing database 104 which is configured to check if the end-user devices 108 requesting for programming content are billed to receive the programming content for delivery of the personalized advertisement to each of the potential users.

As depicted in FIG. 1A, in an exemplary embodiment of the present invention, the personalized advertisement platform 102 may be deployed in a server (not shown) outside the broadcast network 110. Further, as depicted in FIG. 1B, in another exemplary embodiment of the present invention, the personalized advertisement platform 102 may be deployed in an intermediary server (not shown) between the media server 106 and the end-user devices 108.

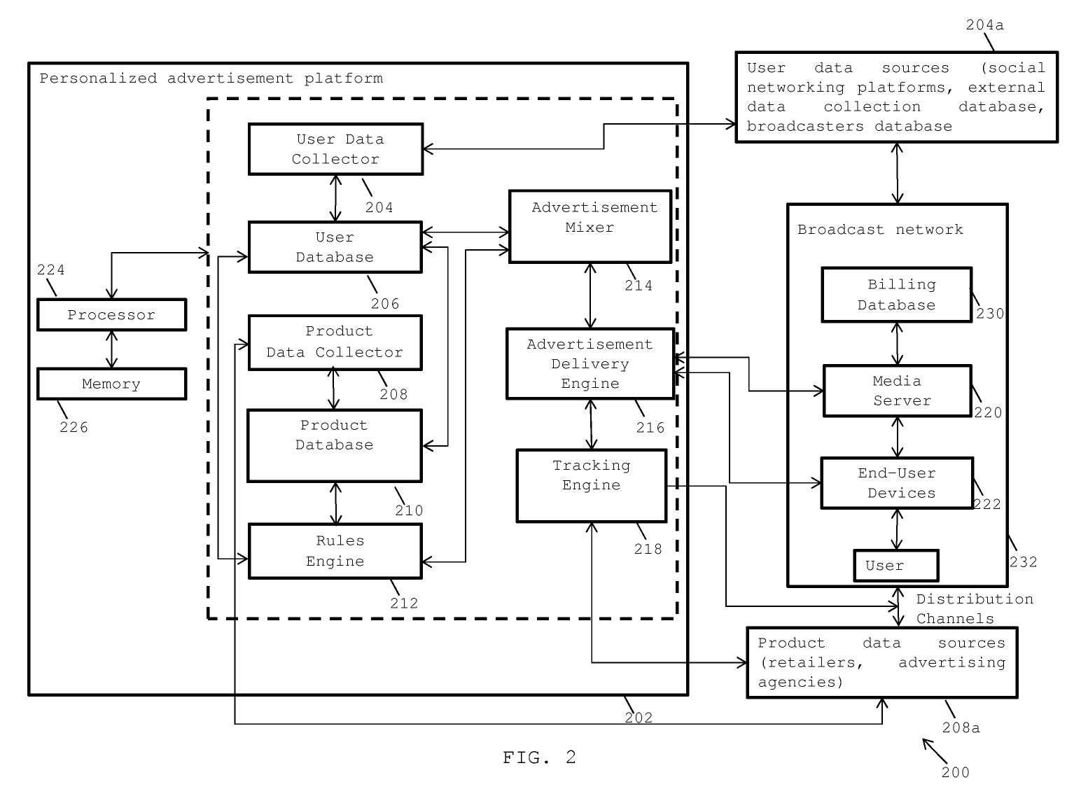

FIG. 2 is a detailed block diagram of a system for creating and delivering personalized advertisements on targeted communication channels and tracking users' responses to the personalized advertisements, in accordance with an embodiment of the present invention. The system 202 (i.e. personalized advertisement platform) comprises a user data collector 204, a user database 206, a product data collector 208, a product database 210, a rules engine 212, an advertisement mixer 214, an advertisement delivery engine 216 and a tracking engine 218. The user data collector 204, the user database 206, the product data collector 208, the product database 210, the rules engine 212, the advertisement mixer 214, the advertisement delivery engine 216 and the tracking engine 218 execute various functionalities via a processor 224 using program instructions stored in a memory 226.

As shown in FIG. 2, in an embodiment of the present invention, the system 202 communicates with a media server 220 and end-user devices 222 in a broadcast network 232. The broadcast network 232 broadcasts programming content to the end-user devices 222 via the media server 220. The end-user devices 222 receive the broadcasted programming content via respective communication channels. Examples of end-user devices 222 include analog cable television, set-top box television, digital cable television etc. Other examples of end-user devices 222 may include smart television, Internet Protocol television (IP TV), and in-store displays in retail outlets.

Various embodiments of the present invention are described in conjunction with one of the communication channels i.e. digital television (e.g. set-top box television). However, it will be apparent to a person skilled in the art that the principles of the present invention may be applied to other communication channels i.e. streaming video environment (e.g. IP TV), and cable television.

In an embodiment of the present invention, the user data collector 204 is configured to collect data related to various users from one or more user data sources 204a. The users are consumers of broadcast content and are subscribed to the personalized advertisement platform (i.e. system 202). In an exemplary embodiment of the present invention, the one or more user data sources 204a may include one or more social networking platforms, and the user data collector 204 fetches user related data from a social data collection application hosted in the one or more social networking platforms. Examples of social networking platforms may include, but are not limited to, Facebook, Gmail, and Twitter. The user related data may include, but are not limited to, name, mobile number, email address, images of the user, various product preferences, and user preferred advertisements. The subscribed users are registered with the social data collection application. As per terms and conditions of the registered users, the user data collector 204 can fetch the user related data via the social data collection application. In another exemplary embodiment of the present invention, the one or more user data sources 204a may include search websites such as Google and the social data collection application may be hosted in the search websites which collects user related data based on search strings provided by the users. The social data collection application may also collect user related data from webmails such as Gmail.

In another exemplary embodiment of the present invention, the one or more user data sources 204a may include a broadcaster database (not shown) of the broadcast network 232. The broadcaster database (not shown) includes user related data such as user identification (id), user name, telephone number, address, email identification (id) and end-user device identification such as set-top box identification (id). The user data collector 204 may fetch user related data from the broadcaster database. In yet another exemplary embodiment of the present invention, the one or more data sources 204a may include external data collection databases which collect user related data from various websites accessed by the users by identifying buying patterns of the users and searches made by the users using web crawling softwares. The user data collector 204 may fetch user related data from the external data collection databases. In an exemplary embodiment of the present invention, the user data collector 204 may obtain data related to time-slots preferred by the user for viewing programming content by monitoring the end-user devices 222.

In an embodiment of the present invention, the user data collector 204 processes and stores the data related to various subscribed users fetched from the one or more user data sources 204a. Based on the processing, the user data collector 204 assigns a unique profile identification to each user and correlates the processed data to corresponding users. The processed data related to the various users may then be transformed into a predetermined data format. In an example, the predetermined data format may include a user social graph data. The user social graph data represents links/relationships between each user's profile details (e.g. name, telephone number, email id and address,) their images (i.e. various pictures of the users), their preferences (e.g. product, advertisement types etc.) and their relationship with other users (friends, family etc.).

In an embodiment of the present invention, the user social graph data, user profile details, user preferences, and user image data are stored in the user database 206. In an exemplary embodiment of the present invention, the user database 206 may be implemented as a cloud database in a cloud-computing network. The cloud database may be periodically monitored to check the quality and consistency of the user related data.

In an embodiment of the present invention, the product data collector 208 is configured to collect data related to various products from one or more product data sources 208a. In an exemplary embodiment of the present invention, the product data sources 208a may include retailer databases and various advertisement agency databases which are subscribers of the personalized advertisement platform (i.e. system 202).

In an exemplary embodiment of the present invention, product related data may include, but are not limited to, product type, product name, product image, product identification (id), target market information for product sale, target demographics, and preferences of the retailers and advertisement agencies for selecting target groups of users. Examples of products may include, but are not limited to, jewelry, apparels, accessories, furniture, cosmetics etc. In another exemplary embodiment of the present invention, the data related to various products may include campaign details which are associated with the products for which the retailers or advertisement agencies wish to run their campaigns. The campaign details may include, but are not limited to, campaign name, campaign identification (id), profile information of target group of users of the products, campaign date and campaign location.

In an embodiment of the present invention, the product data collector 208 processes and stores the product related data and campaign data collected from the one or more product data sources 208a. The processed data is then transformed into a predetermined data format and stored in the product database 210. In an exemplary embodiment of the present invention, the product database 210 may be implemented as a cloud database in a cloud-computing network. The cloud database may be periodically monitored by brand managers of retail outlets and advertising agencies to check accuracy of the product data and to update the product database 210 with necessary product data.

In an embodiment of the present invention, the rules engine 212 is configured to use the data stored in the user database 206 and the product database 210 to facilitate creation of personalized advertisements by applying one or more rules. In particular, the rules engine 212 is configured to define one or more rules for selecting potential users for whom advertisements of products and/or services are to be created and retrieve relevant data of the potential users. The rules engine 212 is configured to automate the interaction between the user database 206 and the product database 210 and is further configured to automate the process of searching and selecting potential users from the user database 206 for creating personalized advertisements for the potential users.

In an exemplary embodiment of the present invention, the rules engine 212 is configured to create two sets of data based on the one or more rules. One set may be referred as filter criteria data and the other set may be referred as mandatory data. The mandatory data is created using the data from the product database 210 based on the one or more rules. The filter criteria data is created to query the user database 206 to identify potential users based on the mandatory data and retrieve user related data corresponding to the potential users.

In an exemplary embodiment of the present invention, the one or more rules may include identifying campaign data in the product database 210 at one or more predetermined times and selecting potential users from the user database 206 based on the campaign data. The rules engine 212 creates the mandatory data by using campaign data and product data from the product database 210 which includes campaign ids identifying one or more campaigns at one or more predetermined times, campaign name, target users associated with the campaigns etc. (e.g. users aged 25-40). The mandatory data further includes product data such as product id, product names, product types for each of the products associated with the identified campaigns. Further, the rules engine 212 creates the filter criteria data to retrieve profile id, user images, contact information (e.g. email id, phone no. address) etc. of the target users identified in the mandatory data from the user database 206. The filter criteria data may also include data to identify more users from the user database 206 based on preferences of the users for products identified in the mandatory data.

The rules engine 212 obtains a list of potential users and the associated user related data from the user database 206 for each of the campaign ids identified in the mandatory data. The rules engine 212 then maps each of the potential user data to corresponding product-campaign information. In particular, the rules engine 212 maps user information i.e. profile id, user images and preferences of each of the potential users to corresponding product ids of the products associated with the campaigns and sends the mapped data to the advertisement mixer 214. In an exemplary embodiment of the present invention, the rules engine 212 uses Business Process Mapping (BPM) tools for defining one or more rules and orchestrating the upstream process of data gathering from the user database 206, the product database 210 and the downstream process of creating and delivering the personalized advertisement.

In an embodiment of the present invention, the advertisement mixer 214 is configured to receive the mapped data for all the identified potential users and create personalized advertisements for each of the potential users. In an exemplary embodiment of the present invention, the advertisement mixer 214 includes an advertisement repository (not shown) that contains advertisement content (i.e. static images of the products and dynamic images of the product i.e. advertisement product video) corresponding to various products. The advertisement content may be sourced in from third party advertising agencies (not shown). The advertisement mixer 214 further includes a user repository (not shown) that stores the user data i.e. the user profile details, user product preferences and user images. The advertisement mixer 214 may source in the user information from the user database 206. For a particular potential user, the advertisement mixer 214 analyzes the mapped data to obtain profile id of the potential user and retrieve the potential users' images from the user repository (not shown). Further, the advertisement mixer 214 analyzes the mapped data to obtain the product id, product name etc. and retrieve advertisement content associated with the product from the advertisement repository (not shown).

In an example, if the campaign is associated with a merchandising retail unit, the product id may be XY1457834, the product name may be yellow crew neck tee, campaign id may be CXG12345, the campaign location may be Cleveland, the start and end dates may be 5 Oct. 2013 through 23 Oct. 2013 and the target users for the campaign may be male consumers aged 25-40 yrs. Therefore, the potential users in this example are male users aged 25-40 yrs. The advertisement mixer 214 retrieves an advertisement image for the product yellow crew neck tee from the advertisement repository (not shown) and creates a new advertisement by modifying the retrieved advertisement. The advertisement mixer 214 modifies the retrieved advertisement by combining one or more images of the potential user with the product image i.e. yellow crew neck tee image. In another exemplary embodiment of the present invention, an entirely new advertisement may be generated by merging the pictures of the potential user with the product image(s). In particular, the images of the user are enhanced by suitably merging the contents of the user image(s) with the product image(s). In this example, the user in the image may be shown to wear the yellow crew neck tee image thus forming a personalized advertisement for the potential user. In an exemplary embodiment of the present invention, the advertisement may be created using automated image merging tools and image morphing tools. In another exemplary embodiment of the present invention, the advertisement retrieved from the advertisement repository (not shown) may include an advertisement video for the product i.e. yellow crew neck tee image. The advertisement mixer 214 then modifies the retrieved video by superimposing the one or more images of the potential user in the advertisement video to create a personalized advertisement video for the potential user.

In an exemplary embodiment of the present invention, the personalized advertisement may be further validated and modified for accuracy in terms of appropriateness and aesthetics as well as checked for conformance to regulatory guidelines. In another exemplary embodiment of the present invention, the advertisement mixer 214 may be implemented as a Business Process as a Service (BPaaS) provided by a dedicated team for checking appropriateness, aesthetics and regulatory compliance of the personalized advertisement.

In various exemplary embodiments of the present invention, the created personalized advertisement (text/image/video) may include the profile id of the potential user, the mixed advertisement content and campaign id. Similarly, the advertisement mixer 214 creates multiple personalized advertisements for multiple potential users.

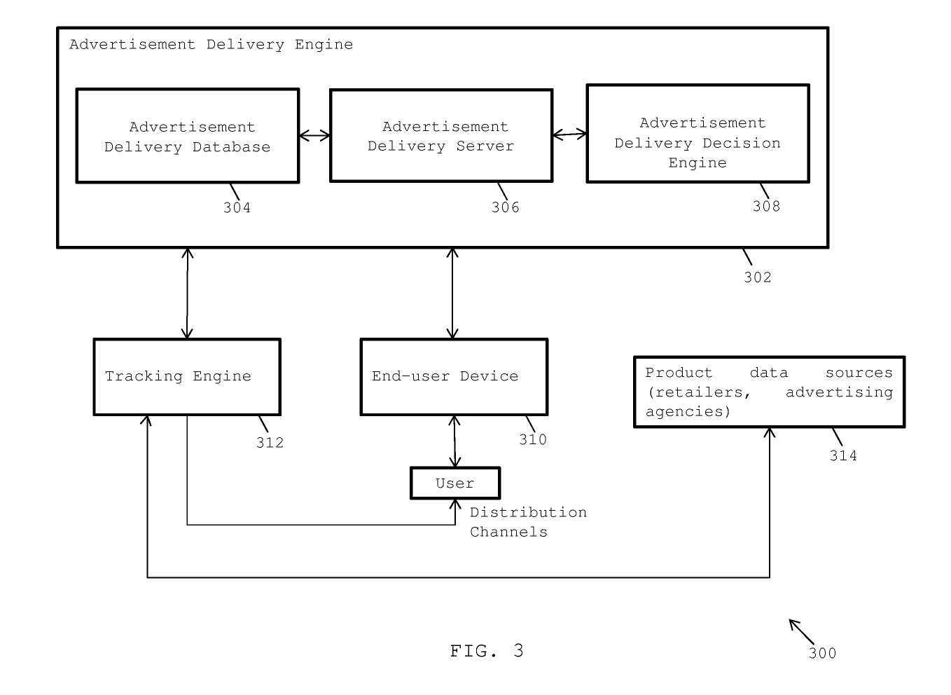

In an embodiment of the present invention, the advertisement mixer 214 sends the created one or more personalized advertisements to the advertisement delivery engine 216. The advertisement delivery engine 216 is configured to deliver the personalized advertisements to the potential users. Further, the tracking engine 218 is configured to track desired actions including sale conversion of the advertised product/service. The advertisement delivery engine 216 and tracking engine 218 are described in detail conjunction with FIG. 3 in the later sections of the specification. In an embodiment of the present invention, the broadcast network 232 includes a billing database 230 which is explained in conjunction with FIGS. 1A and 1B.

FIG. 3 illustrates a detailed block diagram of the advertisement delivery engine in communication with the tracking engine, in accordance with an embodiment of the present invention.

As shown in FIG. 3, the advertisement delivery and tracking engine 302 comprises an advertisement delivery database 304, an advertisement delivery server 306, and an advertisement delivery decision engine 308. The advertisement delivery database 304 stores all the personalized advertisements received from the advertisement mixer 214 (FIG. 2). The advertisement delivery database 304 is configured to generate a unique token for each of the personalized advertisements. The unique token may be a combination of the names, phone numbers or email addresses of the potential users. Each of the generated unique token may be embedded in the corresponding personalized advertisements. In an exemplary embodiment of the present invention, the advertisement delivery server 306 is configured to retrieve the personalized advertisements with the embedded unique tokens from the advertisement delivery database 304 and deliver as well as store the personalized advertisements with the embedded unique tokens in one or more remote devices. In an exemplary embodiment of the present invention, the personalized advertisements with the embedded unique tokens are delivered to the end-user devices 310 such as a set-top boxes of the potential users.

In an embodiment of the present invention, in the event of a programming content broadcast by the media server 220, (FIG. 2) the advertisement delivery decision engine 308 identifies the end-user devices 310 which request the programming content. Amongst the requesting end-user devices 310, the advertisement delivery decision engine 308 identifies the end-user devices 310 that store the personalized advertisements (using the end-user device ids) to determine the potential users as well as the associated campaign details. In particular, the advertisement delivery decision engine 308 uses the profile ids and campaign ids of the potential users as provided in the personalized advertisements to obtain the potential user's data such as name, and one or more campaign details such as start and end time of the campaign, campaign location etc. in operation with the advertisement mixer 214 (FIG. 2) that stores the user details and product details in the user repository (not shown) and advertisement repository (not shown) respectively. Based on the determination, the advertisement delivery decision engine 308 places the personalized advertisements in the programming content of the potential users at a predetermined personalized advertisement time slot. The advertisement delivery decision engine 308 then delivers the programming content along with the personalized advertisements to the potential users' requesting end-user devices 310.

In another exemplary embodiment of the present invention, the advertisement delivery server 306 is configured to deliver the personalized advertisements in real time to the requesting end-user devices 310. The advertisement delivery decision engine 308 uses the profile ids and campaign ids of the potential users as provided in the personalized advertisements to obtain the one or more potential user data such as name, and one or more campaign details such as start and end time of the campaign, campaign location etc. in operation with the advertisement mixer 214 (FIG. 2) that stores the user details and product details in the user repository (not shown) and advertisement repository (not shown) respectively. Based on the determination, the advertisement delivery decision engine 208 places the personalized advertisements in the programming content of the potential users at a predetermined personalized advertisement time slot. The advertisement delivery decision engine 208 then delivers the programming content along with the personalized advertisements to the potential users' requesting end-user devices 310.

It will be understood to a person skilled in the art that the advertisement delivery decision engine 308 delivers the programming content along with the personalized advertisements to the potential users' end-user devices 310 employing various known broadcasting mechanisms such as unicast mechanisms, multicast mechanisms or hybrid unicast-multicast mechanisms.

In an embodiment of the present invention, the tracking engine 312 is configured to monitor and track the users' response to the delivered personalized advertisements via various distribution channels. The tracking engine 312 tracks the users' responses via the embedded unique token in the personalized advertisements when the users make a purchase of the advertised product via the various distribution channels. The distribution channels may include online channels, telecommunication channels, store purchase channels, return path data streams from set-top boxes to analyze users' responses to ‘buy options’ provided to the users etc. In the event of sale of a particular advertised product, the tracking engine 312 determines purchase records of the potential users via the product data sources 314. Thus, the tracking engine 312 facilitates to analyze return on investment of the products advertised using the personalized advertisement platform in accordance with various embodiments of the present invention. In an embodiment of the present invention, the tracking engine 312 may send the purchase records to the advertisement delivery database 304 for future reference.

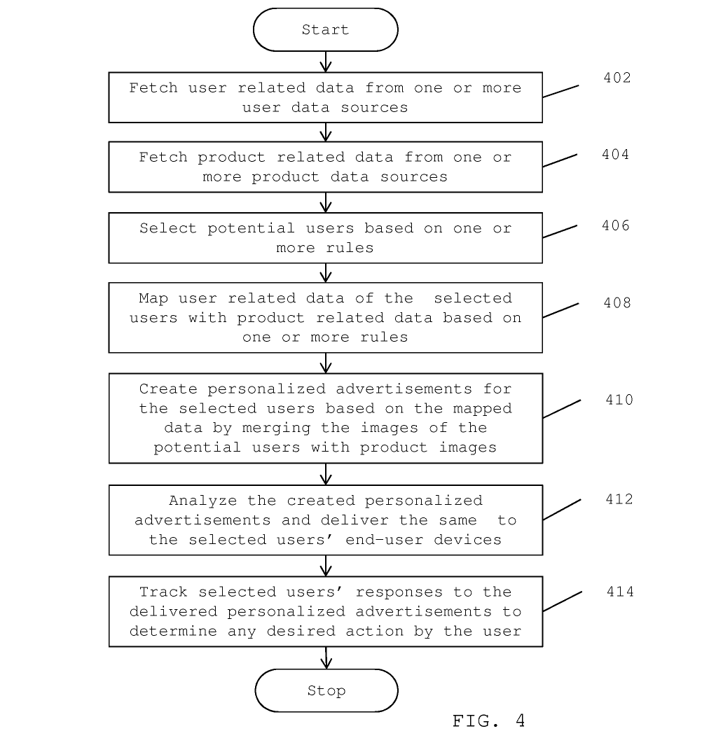

FIG. 4 is a flowchart of a method for creating and delivering personalized advertisements on targeted communication channels and tracking users' responses to the delivered personalized advertisements, in accordance with various embodiments of the present invention.

At step 402, user related data is fetched from one or more user data sources. In an embodiment of the present invention, the users are the consumers of programming content broadcasted by the one or more broadcast networks and are subscribed to the personalized advertisement delivery platform (as discussed in conjunction with FIG. 2). The one or more user data sources may include, but are not limited to, social networking platforms, broadcaster database and external data collection databases. The user related data may include but are not limited to, name, mobile number, email address, pictures of the user, various product preferences, and user preferred advertisements. The user related data is fetched for various subscribed users from the one or more data sources and the fetched data is processed. Based on the processing, profile identification takes place and a unique profile id is assigned to each user. The processed data related to the various users may then be transformed into a predetermined data format. In an example, the predetermined data format may include a user social graph data. The user social graph data represents links/relationships between the user profile details (e.g. name, telephone number, email id and address), user images (i.e. various pictures if the users), and user preferences (e.g. product, advertisement types etc.). The user social graph data at a future point of time may be used to identify friends and other relations of the particular user. The user social graph data, user profile details, user preferences, and user image data are then stored in the user database (as discussed in conjunction with FIG. 2).

At step 404, product related data is fetched from one or more product data sources. In an embodiment of the present invention, the product data sources may include retailer databases and various advertisement agency databases which are also the subscribers of the personalized advertisement platform. The product related data may include, but is not limited to, product type, product name, product image, product identification (id), target market information for product sale, target demographics, and preferences of the retailers and advertisement agencies for selecting target groups of users. In another exemplary embodiment of the present invention, the data related to various products may include campaign details which are associated with the products for which the retailers or advertisement agencies wish to run their campaigns. The campaign details may include, but are not limited to, campaign name, campaign identification (id), profile information of target group of users of the products, campaign date and campaign location. Based on the processing, the fetched data is correlated to corresponding products. The processed data related to the various products is then transformed into a predetermined data format and stored in a product database (as discussed in conjunction with FIG. 2).

At step 506, one or more potential users are selected based on one or more rules. In an embodiment of the present invention, one or more rules are defined for selecting potential users for whom advertisements of products and/or services are to be created and for retrieving relevant data of the potential users. Further, two sets of data may be created based on the one or more rules. One set may be referred as mandatory data (i.e. first set) and the other set may be referred as filter criteria data (i.e. second set). The mandatory data is created using the data from the product database based on the one or more rules. The filter criteria data is created to query the user database to identify potential users based on the mandatory data and retrieve user related data corresponding to the potential users. In an exemplary embodiment of the present invention, the one or more rules may include identifying campaign information in the product database at one or more predetermined times and selecting potential users from the user database based on the campaign information. The mandatory data may be created by using campaign details and product details from the product database which includes campaign ids identifying one or more campaigns at the one or more predetermined times, campaign name, target users associated with the campaigns etc. (e.g. users aged 25-40). The mandatory data further includes product details such as product id, product names, product types for each of the products associated with the identified campaigns. Further, the filter criteria data is created to retrieve profile id, user images, contact information (e.g. email id, phone no. address) etc. of the target users identified in the mandatory data from the user database. The filter criteria data may also include data to identify users from the user database based on preferences of the users for products identified in the mandatory data.

At step 408, user related data of the one or more selected users are mapped with product related data based on one or more rules. In an embodiment of the present invention, a list of the selected users and the associated user related data is obtained from the user database for each of the campaign ids identified in the mandatory data. Subsequently, each of the selected user data is mapped to corresponding product-campaign information. In particular, profile id, user images and preferences of each of the potential user is mapped to corresponding product ids of the products associated with the campaigns.

At step 410, personalized advertisements are created for the one or more selected users based on the mapped data by merging the images of the selected users with product advertisements images or product video. In an embodiment of the present invention, the mapped data is analyzed to obtain the selected users' data e.g. the user images of the selected users and his preferences as well as the product data e.g. the product id, product name and campaign information. In an example, if the campaign is associated with a merchandising retail unit, the product id may be XY1457834, the product name may be yellow crew neck tee, campaign id may be CXG12345, the campaign location may be Cleveland, the start and end dates may be 5 Oct. 2013 through 23 Oct. 2013 and the target users for the campaign may be male consumers aged 25-40 yrs. Therefore, the selected users in this example are male users aged 25-40 yrs. An advertisement image for the product yellow crew neck tee is retrieved from an advertisement content database and a new advertisement is created by modifying the retrieved advertisement. The retrieved advertisement is modified by combining one or more images of the selected users with the product image(s) i.e. yellow crew neck tee shirt image. In another exemplary embodiment of the present invention, an entirely new advertisement may be generated by merging the pictures of the selected users with the product image(s). In particular, the images of the user are enhanced by suitably merging the contents of the user image(s) with the product image(s). In this example, the user in the image may be shown to wear the yellow crew neck tee shirt image thus forming a personalized advertisement for the selected user. In another exemplary embodiment of the present invention, the advertisement retrieved from the advertisement database may include an advertisement video for the product i.e. yellow crew neck tee shirt image. The retrieved video is then modified by superimposing one or more images of the selected users in the advertisement video to create a personalized advertisement video for the potential users. In an exemplary embodiment of the present invention, the personalized advertisement may be further validated and modified for accuracy in terms of appropriateness and aesthetics as well as checked for conformance to regulatory guidelines. In another exemplary embodiment of the present invention, the creation of such personalized advertisements may be provided as a Business Process as a Service (BPaaS) through a dedicated team of “Image enhancers” for checking appropriateness, aesthetics and regulatory compliance of the personalized advertisement video. In various exemplary embodiments of the present invention, the personalized advertisement image/video may include the profile ids of the selected users, the mixed advertisement content and campaign ids.

At step 412, the created personalized advertisements are analyzed and delivered to the selected users' end-user devices. In an embodiment of the present invention, a unique token for each of the personalized advertisements is generated. The unique token may be a combination of the name, phone number or email address of the selected users. Each of the generated unique token may be embedded in the corresponding personalized advertisements. The personalized advertisements with the embedded unique tokens are then delivered as well as stored in one or more remote devices. In an exemplary embodiment of the present invention, the personalized advertisements with the embedded unique tokens are delivered to end-user devices such as set-top boxes of the selected users (as discussed in conjunction with FIG. 2) and stored in the end-user devices. In the event of a programming content broadcast by the media server, the end-user devices which request the programming content are identified. Amongst the requesting end-user devices the end-user devices that store the personalized advertisements are identified to determine the potential users as well as the associated campaign details. In particular, profile ids and campaign ids of the selected users as provided in the personalized advertisements are used to obtain the selected user's data such as name, and one or more campaign details such as start and end time of the campaign, campaign location etc. Based on the determination, the personalized advertisements are placed in the programming content of the selected users at a predetermined personalized advertisement time slot. The programming content along with the personalized advertisements are then delivered to the selected users' requesting end-user devices.

In another exemplary embodiment of the present invention, the personalized advertisements are delivered in real time to the requesting end-user devices. The profile ids and campaign ids of the selected users as provided in the personalized advertisements are then used to obtain the selected users' data such as name, and one or more campaign details such as start and end time of the campaign, campaign location etc. Based on the determination, the personalized advertisements are placed in the programming content of the selected users at a predetermined personalized advertisement time slot. The programming content along with the personalized advertisements are then delivered to the potential users' requesting end-user devices.

At step 414, the selected users' responses to the delivered personalized advertisements are tracked to determine any desired action by the user. In an embodiment of the present invention, the users' responses to the delivered personalized advertisement are monitored and tracked via various distribution channels. The distribution channels may include online channels, telecommunication channels, store purchase channels, return path data streams from set-top box to analyze users' responses to ‘buy options’ provided to the users etc. The users' responses are tracked via the embedded unique token in the personalized advertisements when the users make a purchase of the advertised product via the various distribution channels. Further, purchase records of all the selected users are stored to analyze the return on investment of the products advertised using the personalized advertisement platform in accordance with various embodiments of the present invention. Similarly, in another exemplary embodiment of the present invention, in case of a non-commercial advertisement such as a polio drop advertisement, the users' actions are tracked.

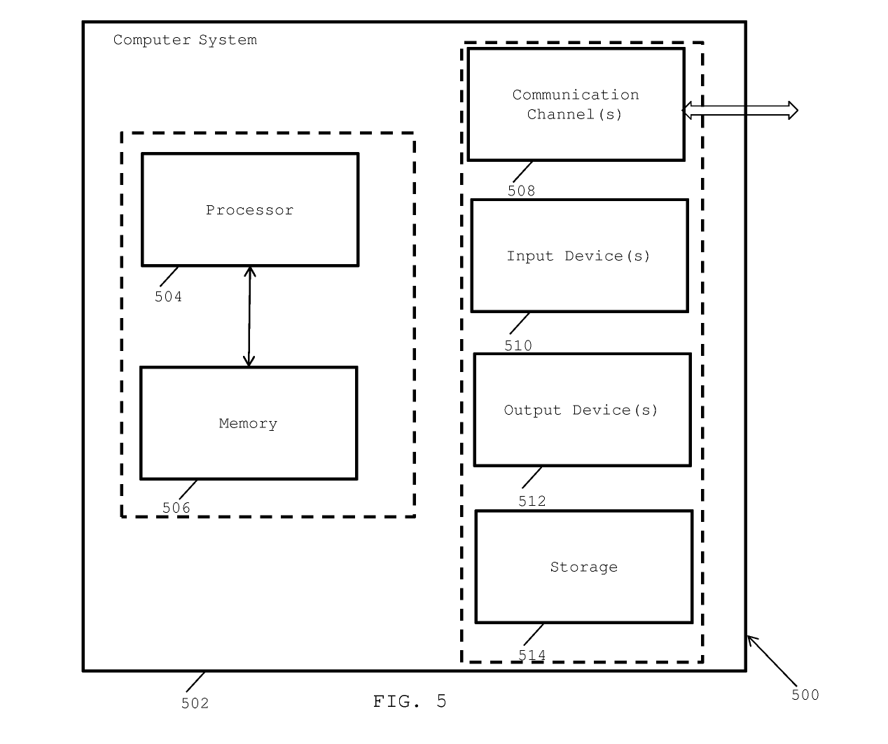

FIG. 5 illustrates an exemplary computer system in which various embodiments of the present invention may be implemented.

The computer system 502 comprises a processor 504 and a memory 506. The processor 504 executes program instructions and may be a real processor. The processor 504 may also be a virtual processor. The computer system 502 is not intended to suggest any limitation as to scope of use or functionality of described embodiments. For example, the computer system 502 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 510 may include, but not limited to, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In various embodiments of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method for creating personalized advertisements and delivering the created personalized advertisements to one or more end-user devices via associated communication channels, the method comprising:
selecting one or more users, via a processor, for whom personalized advertisements are to be created, from a plurality of users based on one or more rules, the one or more rules being defined for selecting users based on: product related data obtained from one or more product data sources and user related data of the plurality of users obtained from one or more user data sources;
mapping, via the processor, user related data of the selected users with product related data based on the one or more rules to generate mapped data for each of the selected users;
creating, via the processor, personalized advertisements for each of the selected users based on the mapped data, wherein the personalized advertisements are created by merging images of the selected users with one or more product advertisement images; and
analyzing, via the processor, the created personalized advertisements of each of the selected users to deliver the created personalized advertisements to each of the selected users' end-user devices respectively.

2. The method of claim 1 further comprising: tracking the selected users' responses to the delivered personalized advertisements to analyze sale of the advertised products.

3. The method of claim 1, wherein the communication channels comprise digital television, streaming video, switched digital video and cable television.

4. The computer-implemented method of claim 1, wherein the one or more user data sources comprise social networking platforms, broadcaster database and external data collection databases.

5. The computer-implemented method of claim 1, wherein the user related data comprises name, mobile number, email address, images of the users, product preferences of the users, and advertisements preferred by the users.

6. The computer-implemented method of claim 1, wherein the user related data of the plurality of users are processed and stored in a user database in a predetermined format and further wherein a unique profile identification is assigned to each user.

7. The computer-implemented method of claim 1, wherein the product related data of the plurality of users are processed and stored in a product database in a predetermined format and further wherein a unique product identification is assigned to each product.

8. The computer-implemented method of claim 1, wherein the product related data comprises product identification, product type, product name, product image, target market information for product sale, target demographics, preferences of retailers and advertisement agencies for selecting target groups of users, campaign identification, campaign name, profile information of target group of users of the products, campaign date and campaign location.

9. The computer-implemented method of claim 1, wherein selecting one or more users, for whom personalized advertisements are to be created, from a plurality of users based on one or more rules comprises:
identifying campaign details related to campaigns for products in a product database at one or more predetermined times; and
selecting one or more users from the user database for each of the identified campaign details.

10. The computer-implemented method of claim 9 further comprising:
creating a first set of data based on the one or more rules, the first set of data is created using product related data retrieved from the product database for each of the identified campaigns; and
creating a second set of data based on the one or more rules, the second set is created for querying the user database to select one or more users and retrieve user related data of the selected users based on at least one of: the first set of data and data for querying the user database based on preferences of the users for products identified in the first set of data.

11. The computer-implemented method of claim 1, wherein mapping user related data of the selected users with product related data based on the one or more rules comprises mapping profile identification, user images and preferences of each of the selected users with corresponding product identifications of the products identified based on the one or more rules.

12. The computer-implemented method of claim 1, wherein creating personalized advertisements for the one or more selected users based on the mapped data by merging images of the selected users with at least one of product advertisement images comprises:
analyzing the mapped data for each of the selected users to retrieve an advertisement product image or advertisement product video corresponding to products identified by the product identifications in the mapped data;
merging one or more user images of the selected users with the retrieved advertisement product images or advertisement video, the selected users being identified by corresponding profile identifications in the mapped data; and
creating a personalized advertisement for each of the selected users based on the merging.

13. The computer-implemented method of claim 12, wherein the created personalized advertisements comprises profile identifications of the users, merged advertisement content and campaign identifications.

14. The computer-implemented method of claim 1, wherein analyzing the created personalized advertisements of each of the selected users and delivering the created personalized advertisements to the selected users' end-user devices comprises:
generating a unique token for each of the created personalized advertisements, wherein each of the generated unique token is embedded in the corresponding created personalized advertisements;
storing the created personalized advertisements with the embedded unique tokens in one or more remote devices;
determining the selected users of each of the created personalized advertisements and associated campaign details based on the profile identifications and campaign identifications in the created personalized advertisements; and
placing the created personalized advertisements in the programming content of each of the selected users at predetermined time slots.

15. The computer-implemented method of claim 2, wherein tracking the selected users' responses to the delivered personalized advertisements to analyze sale of the advertised products comprises:
monitoring the selected users' responses via one or more distribution channels; and
tracking the selected users' purchase details of the personalized advertisements via the embedded unique tokens in the personalized advertisements.

16. A system for creating personalized advertisements and delivering the created personalized advertisements to one or more end-user devices via associated communication channels, the system comprising:
a rules engine in communication with a processor and configured to:
select one or more users, for whom personalized advertisements are to be created, from a plurality of users based on one or more rules, the one or more rules being defined for selecting users based on: product related data obtained from one or more product data sources and user related data of the plurality of users obtained from one or more user data sources; and
map user related data of the selected one or more users with product related data based on the one or more rules to generate mapped data for each of the selected users;
an advertisement mixer in communication with the processor and configured to create personalized advertisements for each of the selected users based on the mapped data, wherein the personalized advertisements are created by merging images of the selected users with product advertisement images; and
an advertisement delivery engine in communication with the processor and configured to analyze the created personalized advertisements of each of the selected users and deliver the created personalized advertisements to the selected users' end-user devices respectively.

17. The system of claim 16 further comprising a tracking engine configured to track the selected users' responses to the delivered personalized advertisements to analyze sale of the advertised products.

18. The system of claim 16, wherein the communication channels comprise digital television, streaming video, switched digital video and cable television.

19. The system of claim 16 further comprising a user data collector in communication with the processor and configured to collect user related data from the one or more user data sources.

20. The system of claim 16 further comprising a product data collector in communication with the processor and configured to collect product related data from the one or more product data sources.

21. The system of claim 19, wherein the user data collector is configured to:
process the user related data of the plurality of users;
assign a unique profile identification to the processed user related data of each of the plurality of users; and
store the processed user related data of the plurality of users in a predetermined format in the user database.

22. The system of claim 20, wherein the product data collector is configured to:
process the product related data corresponding to each of the products;
assign a unique product identification to the processed data corresponding to each of the products; and
store the processed product related data in the product database in a predetermined format.

23. The system of claim 16, wherein the advertisement mixer is configured to create personalized advertisements for each of the selected users based on the mapped data by:
analyzing the mapped data for each of the selected users to retrieve one or more advertisement product images or one or more advertisement product video corresponding to products identified by the product identifications in the mapped data;
merging one or more user images of the selected users with the retrieved advertisement product image or advertisement video, the selected users being identified based on corresponding profile identifications in the mapped data; and
creating a personalized advertisement for each of the selected users based on the merging.

24. The system of claim 16, wherein the advertisement delivery engine comprises an advertisement delivery database configured to:
generate a unique token for each of the personalized advertisements received form the advertisement mixer; and
deliver each of the personalized advertisements embedded with corresponding unique tokens to one or more remote databases.

25. The system of claim 24, wherein the advertisement delivery engine comprises an advertisement delivery server is configured to deliver each of the personalized advertisements embedded with corresponding unique tokens to the end-user devices.

26. The system of claim 24, wherein the advertisement delivery engine comprises an advertisement delivery decision engine configured to:
identify the end-user devices requesting for programming content via one or more broadcast networks;
retrieve the created personalized advertisements from the one or more remote devices;
determine the selected users of each of the created personalized advertisements and associated campaign details for each of the identified end-user devices, wherein the selected users and associated campaign details are determined based on corresponding profile identifications and campaign identifications in the created personalized advertisements; and
place the created personalized advertisements in the programming content of the selected users at predetermined time slots.

27. The system of claim 17, wherein the tracking engine is configured to:
monitor the selected users' end-user devices via one or more distribution channels; and
track the selected users' response to the personalized advertisements via the embedded unique tokens in the personalized advertisements.

28. A computer program product comprising:
a non-transitory computer-readable medium having computer-readable program code stored thereon, the computer-readable program code comprising instructions that, when executed by a processor, cause the processor to:
select one or more users, for whom personalized advertisements are to be created, from a plurality of users based on one or more rules, the one or more rules being defined for selecting users based on: product related data obtained from one or more product data sources and user related data of the plurality of users obtained from one or more user data sources;
map user related data of the selected one or more users with product related data based on the one or more rules to generate mapped data for each of the one or more selected users;
create personalized advertisements for the one or more selected users based on the mapped data, wherein the personalized advertisements are created by merging images of the selected users with the product advertisement images; and
analyze the created personalized advertisements of each of the selected users and deliver the created personalized advertisements to the selected users' end-user devices respectively.
